(19) United States
(12) Patent Application Publication
(10) Pub. No.: US 2025/0113944 A1
(43) Pub. Date: Apr. 10, 2025

(54) Electric Cooking Appliance

(71) Applicant: SEB S.A., Ecully (FR)

(72) Inventors: Marie Dussart, Ecully Cedex (FR); Johann Petitallot, Ecully Cedex (FR)

(73) Assignee: SEB S.A., Ecully (FR)

(21) Appl. No.: 18/906,702

(22) Filed: Oct. 4, 2024

(30) Foreign Application Priority Data
Oct. 5, 2023 (FR) 23/10663

(51) Int. Cl. A47J 37/06

(52) U.S. Cl. CPC A47J 37/0641; A47J 37/0664

(57) ABSTRACT

An electric cooking appliance includes a casing having a receiving compartment and a cooking recipient configured to be housed at least partially inside the receiving compartment. The cooking recipient includes a recipient bottom, a baking tray, and a hot-air heating system configured to heat and cook foodstuffs. The electric cooking appliance further includes a positioning system configured to position the baking tray in at least one first cooking position in which the baking tray extends in a first cooking plane and is located a first distance from the recipient bottom, and in a second cooking position in which the baking tray extends in a second cooking plane and is located a second distance from the recipient bottom which is smaller than the first distance.

### TECHNICAL FIELD

The present invention generally relates to an electric cooking appliance, for cooking food products according to at least one hot-air cooking mode.

### PRIOR ART

It is known from the prior art to use an electric cooking appliance configured to cook foodstuffs, and comprising:
a casing comprising a receiving compartment;
a cooking recipient configured to be housed at least partially inside the receiving compartment, the cooking recipient including a recipient bottom and peripheral walls extending from the recipient bottom and delimiting, together with the recipient bottom, a cooking volume;
a baking tray configured to be supported by the cooking recipient and to support the foodstuffs; and
a hot-air heating system configured to heat and cook the foodstuffs present inside the receiving compartment according to a hot-air cooking mode.

Such an electric cooking appliance enables the user to carry out cooking of food products inside the cooking recipient, and more particularly on the baking tray when the baking tray is supported by the cooking recipient.

This type of electric cooking appliances is particularly effective as it enables the user to carry out cooking of food products inside the cooking recipient in an extremely simple manner; indeed, all it needs is to dispose the food products over the baking tray and launch the operation of the electric cooking appliance. However, such an electric cooking appliance has limited cooking performances in particular because of the specific position occupied by the baking tray with respect to the cooking recipient.

### SUMMARY OF THE INVENTION

Hence, the technical problem at the origin of the invention consists in providing an electric cooking appliance, designed for cooking food products according to at least one hot-air cooking mode and which is modulable, while having a simple, compact and economical structure.

To this end, the present invention relates to an electric cooking appliance configured to carry out foodstuff cooking, and comprising:
a casing comprising a receiving compartment;
a cooking recipient configured to be housed at least partially inside the receiving compartment, the cooking recipient including a recipient bottom and peripheral walls extending from the recipient bottom and delimiting with the recipient bottom a cooking volume;
a baking tray, such as a cooking grid for example, configured to be supported by the cooking recipient and to support the foodstuffs to be cooked;
a hot-air heating system configured to heat and cook the foodstuffs present inside the receiving compartment according to at least one hot-air cooking mode;
   the electric cooking appliance includes a positioning system configured to position the baking tray according to at least one first cooking position in which the baking tray extends in a first cooking plane and is located at a first distance from the recipient bottom, and according to a second cooking position in which the baking tray extends in a second cooking plane and is located at a second distance from the recipient bottom which is smaller than the first distance, and the positioning system includes a support portion disposed in the cooking recipient and a bearing portion disposed on the baking tray and configured to be supported by the support portion, and therefore to bear on the support portion, when the baking tray occupies the first cooking position.

Such a configuration of the invention allows positioning the baking tray in different positions with respect to the recipient bottom, and therefore modifying the distance between the foodstuffs positioned on the baking tray and the heating system when the baking tray rests on the cooking recipient. These arrangements allow optimizing the cooking performances, and for example obtaining more or less grilled or grilled foodstuffs, depending on the cooking position occupied by the baking tray.

Furthermore, it is for example easier to catch salmon fillets when they are cooked on the baking tray occupying the first cooking position, rather than cooked on the baking tray occupying the second cooking position.

The electric cooking appliance may further have one or more of the following features, which may be considered individually or in combination.

According to an embodiment of the invention, the baking tray is configured to be oriented, with respect to the cooking recipient, according to a first relative orientation when the baking tray occupies the first cooking position, and to be oriented, with respect to the cooking recipient, according to a second orientation when the baking tray occupies the second cooking position, the first orientation and the second orientation being angularly offset from one another around an axis of rotation that is transverse to the first firing plane. Such a configuration of the invention advantageously allows facilitating the positioning of the baking tray in either one of the first cooking position and the second cooking position depending on the choice of the user.

According to an embodiment of the invention, the baking tray and the bearing portion are made in one-piece.

According to an embodiment of the invention, the baking tray is configured to be disposed in the cooking volume at least when it occupies the second cooking position, and for example both when it occupies the first cooking position and when it occupies the second cooking position.

According to an embodiment of the invention, the hot-air heating system includes a fan configured to generate an airflow in the cooking volume, and a drive unit configured to drive the fan in rotation.

According to an embodiment of the invention, the hot-air heating system is provided in an upper portion of the casing.

According to an embodiment of the invention, the fan is configured to extend substantially opposite the baking tray.

According to an embodiment of the invention, the hot-air heating system further includes a heating member, such as an electric heating resistance, configured to heat up the airflow generated by the fan.

According to an embodiment of the invention, the cooking recipient and the baking tray are configured to cooperate by form-fitting.

According to an embodiment of the invention, the cooking recipient includes a cross-section with a substantially rectangular or square shape.

According to an embodiment of the invention, the recipient bottom extends substantially horizontally when the cooking recipient is housed in the receiving compartment and the casing rests on a horizontal surface.

According to an embodiment of the invention, the first cooking plane and the second cooking plane are substantially parallel, and are configured to extend substantially horizontally when the casing rests on horizontal surface.

Such a configuration of the invention advantageously enables a good distribution of the foodstuffs over the baking tray when the baking tray occupies either one of the first and second cooking positions and when the lower casing rests on a horizontal surface.

According to an embodiment of the invention, the cooking recipient includes an access opening delimited by an upper peripheral edge of the cooking recipient, the access opening being configured to enable the placement and the removal of the baking tray into and out of the cooking volume, and in particular to enable placement of the baking tray in the first cooking position through at least one vertical translational movement, that is to say substantially perpendicular to the recipient bottom. Such a configuration of the invention and of the access opening enables simplified placement and removal of the foodstuffs on the baking tray.

According to an embodiment of the invention, the support portion includes support members provided on the cooking recipient and configured to cooperate with and support the bearing portion disposed on the baking tray when the baking tray occupies the first cooking position.

According to an embodiment of the invention, the baking tray includes a lower face configured to be oriented towards the recipient bottom and an upper face on which foodstuffs to be cooked are intended to be disposed, the support members being configured to cooperate with a peripheral portion of the lower face of the baking tray when the baking tray occupies the first cooking position, said peripheral portion forming the bearing portion.

According to an embodiment of the invention, each support member includes an upper support face configured to support the bearing portion disposed on the baking tray, and more particularly with a respective portion of the lower face of the baking tray, when the baking tray occupies the first cooking position.

According to an embodiment of the invention, each support member is configured to project inside the cooking volume.

According to an embodiment of the invention, each support member is configured to extend substantially vertically when the casing rests on a horizontal surface.

According to an embodiment of the invention, each support member is a positioning stud.

According to an embodiment of the invention, the support members are configured to enable the passage of the baking tray from the first position towards the second position through an inclination of the baking tray about an axis of inclination. Such a configuration of the invention allows making the baking tray switch from the first cooking position into the second cooking position without requiring any mechanical modification of the baking tray.

According to an embodiment of the invention, the axis of inclination is a substantially horizontal axis passing through two opposite ones of the peripheral walls of the cooking recipient which include no support members.

According to an embodiment of the invention, the baking tray, and advantageously the lower face of the baking tray, is configured to rest on a lower support surface provided on the cooking recipient when the baking tray is in the second cooking position, said lower support surface partially forming the positioning system.

According to an embodiment of the invention, the lower support surface extends over the inner contour of the cooking recipient, and over each of the peripheral walls, such that the lower support surface defines an inner peripheral boundary in the cooking volume.

According to an embodiment of the invention, the support members are provided on at least two peripheral walls of the cooking recipient.

According to an embodiment of the invention, the support members are distributed over two peripheral walls of the cooking recipient which face each other.

According to an embodiment of the invention, the positioning system includes positioning recesses, such as positioning grooves for example, provided on the baking tray, the positioning system being configured so as to enable a displacement of the baking tray in the second cooking position, for example through a substantially vertical translational movement, when each support member is located opposite a respective positioning recess.

According to an embodiment of the invention, the positioning recesses are asymmetrical with respect to a midplane of the baking tray which is perpendicular to a plane of extension of the baking tray.

According to an embodiment of the invention, the midplane allows defining a symmetry of the contour of the baking tray (positioning recesses excluded), such a configuration of the invention enables a cooperation between the baking tray and an upper portion of the cooking recipient according to at least two different orientations of the baking tray, the two orientations being angularly shifted, for example by a 90° or 180° angle, about an axis of rotation which is transverse to the first cooking plane. Such a configuration of the invention advantageously allows obtaining a baking tray configured to switch from the high cooking position into the low cooking position through a simple translational movement, and obtaining a baking tray that rests on the support members when the baking tray is positioned in the cooking volume after a 180° rotation about the axis of rotation which is transverse to the first cooking plane.

According to an embodiment of the invention, each of the support members includes two lateral guide portions substantially parallel to one another and configured to enable indexing and guidance of the baking tray during displacement thereof towards the second cooking position.

According to an embodiment of the invention, the two lateral guide portions are configured to extend substantially vertically when the casing rests on a horizontal surface.

According to an embodiment of the invention, the lower portion extends from the recipient bottom to the lower support surface. Advantageously, this allows avoiding the foodstuffs present on the baking tray in the cooking juices when the baking tray is positioned in the second cooking position.

According to an embodiment of the invention, the cooking recipient is removable with respect to the casing.

According to an embodiment of the invention, the baking tray further includes a gripping handle configured to enable placement and removal of the cooking recipient into and out of the receiving compartment, for example through a translational movement. Advantageously, the electric cooking appliance is configured such that the translational movement is substantially horizontal when the casing rests on a horizontal surface.

According to an embodiment of the invention, the gripping handle is provided on an external face of one of the peripheral walls.

According to an embodiment of the invention, the gripping handle extends substantially vertically.

According to an embodiment of the invention, the baking tray is configured to be housed in the cooking recipient both when it occupies the first cooking position and the second cooking position.

According to an embodiment of the invention, the casing includes a cap configured to alternately occupy a closure position in which the cap prevents access to the receiving compartment, and an opening position in which the cap enables access to the receiving compartment.

According to an embodiment of the invention, the cap is pivotably mounted about a pivot axis which is substantially horizontal when the casing rests on a horizontal surface.

According to an embodiment of the invention, the baking tray includes gripping means, such as gripping fingers for example, which are configured to enable gripping of the baking tray by insertion of the fingers of the user, when the baking tray is in the first cooking position or in the second cooking position.

According to an embodiment of the invention, each of the support members includes two lateral guide portions substantially parallel to one another and configured to enable indexing and guidance of the baking tray upon displacement thereof towards the second cooking position.

According to an embodiment of the invention, the baking tray is apertured, such that cooking juices produced by foodstuffs disposed on the baking tray could flow by gravity in a lower portion of the cooking recipient.

The invention also relates to a method for using an electric cooking appliance according to the invention, the use method comprising at least one step of pivoting the baking tray about a pivot axis to reach either one of the first cooking position and the second cooking position.

According to an embodiment of the invention, a step of displacing the baking tray from the first cooking position to the second cooking position may comprise at least the following steps:
lifting the baking tray from the first cooking position and at a distance from the support members, for example according to a first ascending translational movement substantially perpendicular to the first cooking plane,
pivoting the baking tray about a pivot axis which is substantially perpendicular to the first cooking plane, so as to position the positioning recesses opposite the support members, the pivoting of the baking tray being for example carried out through a rotation of the baking tray by 180° about the pivot axis,
displacing the baking tray in the direction of the recipient bottom until reaching the second cooking position, for example according to a second descending translational movement substantially perpendicular to the first cooking plane.

According to an embodiment of the invention, a step of displacing the baking tray from the first cooking position to the second cooking position may comprise at least the following steps:
lifting the baking tray from the first cooking position and at a distance from the support members, for example according to a first ascending translational movement substantially perpendicular to the first cooking plane,
pivoting the baking tray about a first pivot axis substantially parallel to the first cooking plane in a first pivot direction and according to a first pivot angle comprised between 10 degrees and 70 degrees, advantageously between 20 degrees and 60 degrees, and like for example 40 degrees,
displacing the baking tray between the support members and in the direction of the recipient bottom until the baking tray is located below the support members, for example according to a second descending translational movement substantially perpendicular to the first cooking plane,
pivoting the baking tray about a second pivot axis substantially parallel to the first cooking plane, in a second pivot direction opposite to the first pivot direction and according to a second pivot angle substantially identical to the first pivot angle, such that the baking tray extends substantially parallel to the second cooking plane,
placing the baking tray in the second cooking position, for example according to a third descending translational movement substantially perpendicular to the second cooking plane.

The first grilled effect and the second grilled effect of the foodstuffs to be cooked differ from each other because of the respective distance between the baking tray and the heating system in the first cooking position and the second cooking position.

Unless stated otherwise, the term “substantially” means, in the present document, “exactly or within a 10% or 20% margin”.

### BRIEF DESCRIPTION OF THE FIGURES

The present invention will be better understood from the following description with reference to the appended figures wherein identical reference signs correspond to structurally and/or functionally identical or similar elements.

FIG. 1 is a perspective view of an electric cooking appliance according to a first embodiment of the invention;

FIG. 2 is a sectional side view of the electric cooking appliance of FIG. 1;

FIG. 3 is a perspective top view of a cooking recipient belonging to the electric cooking appliance of FIG. 1;

FIG. 4 is a schematic sectional view of the cooking recipient of FIG. 3;

FIG. 5 is a schematic sectional view of the cooking recipient of FIG. 3 in which a baking tray is positioned in a first cooking position;

FIG. 6 is a schematic sectional view of the cooking recipient of FIG. 3 in which the baking tray is positioned in a second cooking position;

FIG. 7 is a schematic sectional view of the recipient of FIG. 3 in which the baking tray switches from the first cooking position into the second cooking position;

FIG. 8 is a perspective top view of a cooking recipient as well as a baking tray belonging to an electric cooking appliance according to a second embodiment of the invention;

FIG. 9 is a perspective top view of the cooking recipient and of the baking tray of FIG. 8 in which the baking tray respectively occupies the first cooking position and the second cooking position;

FIG. 10 is a top view of the cooking recipient of FIG. 9 in which the baking tray respectively occupies the first cooking position and the second cooking position.

### DETAILED DESCRIPTION

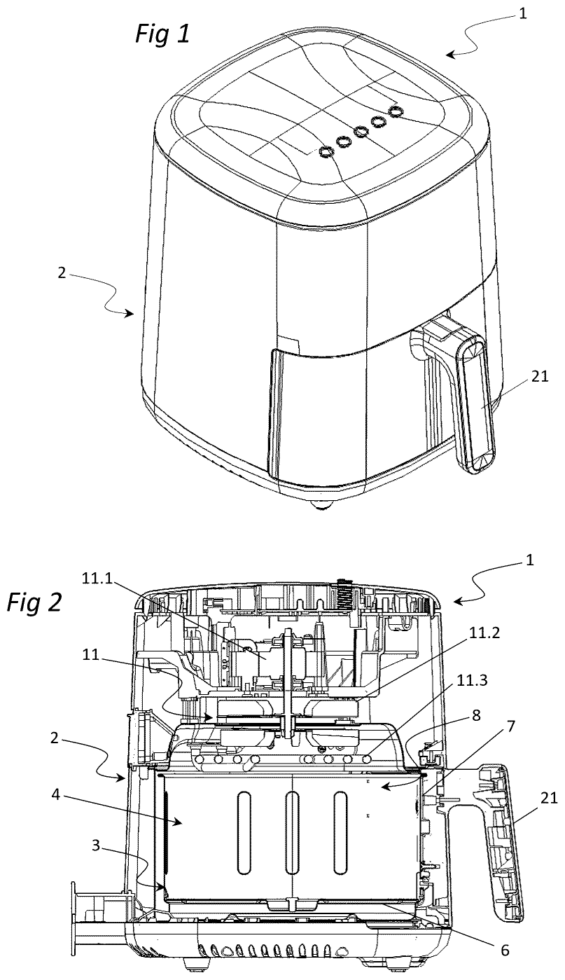

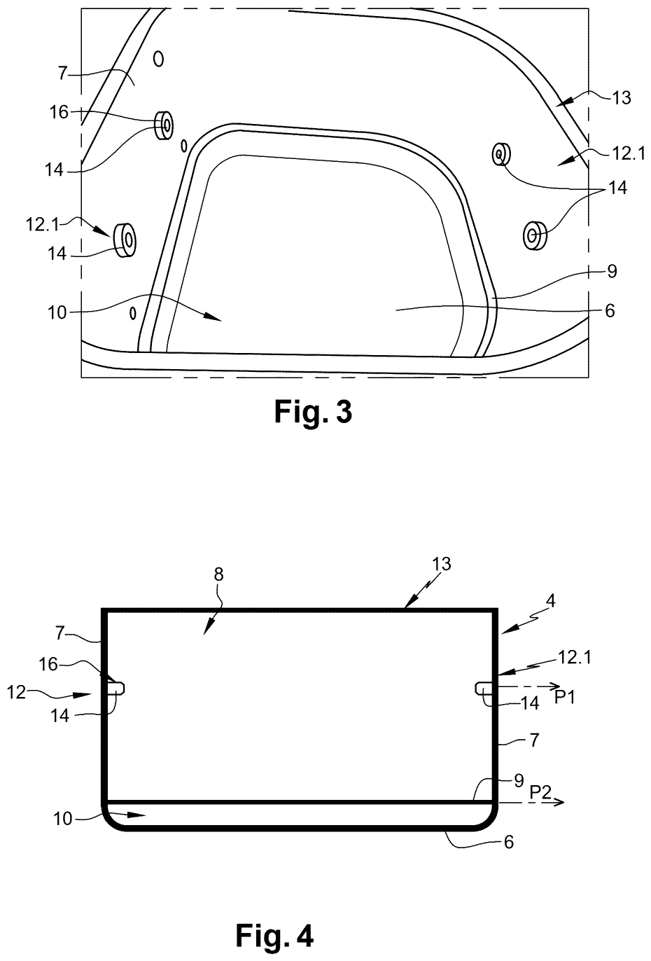

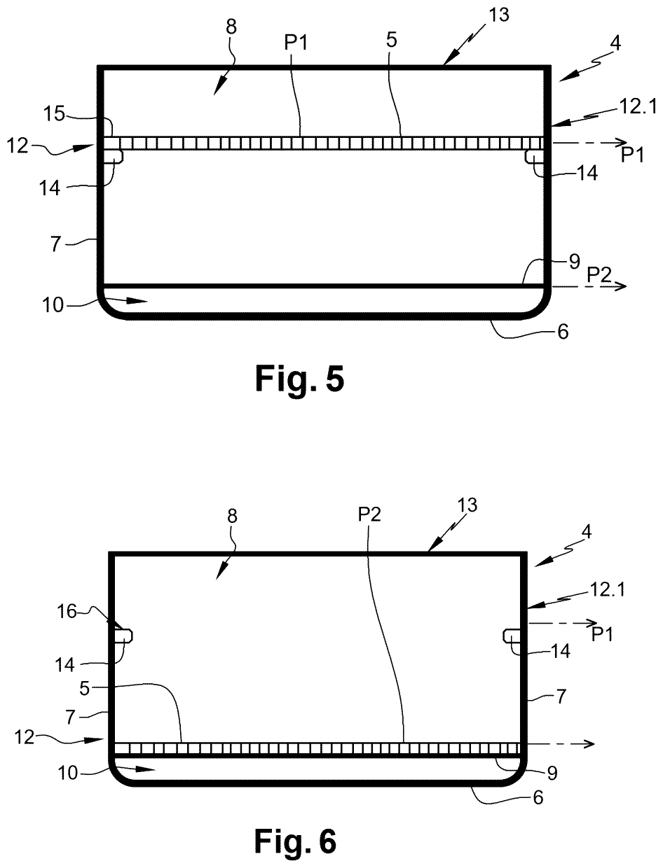

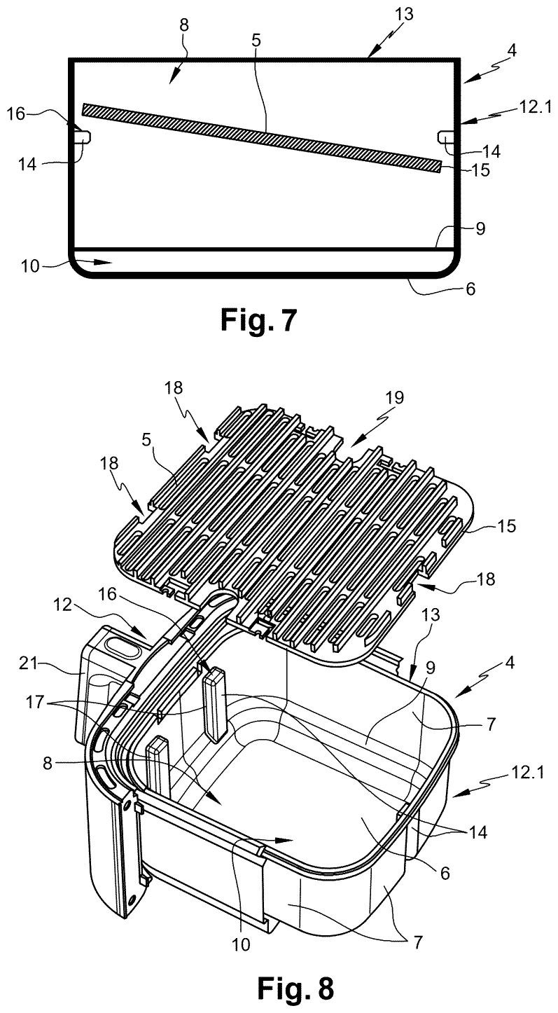

FIGS. 1 to 7 show all or part of an electric cooking appliance 1 configured to cook foodstuffs and according to a first embodiment of the invention. In particular, the electric cooking appliance 1 comprises a casing 2 delimiting a receiving compartment 3, a cooking recipient 4 configured to be housed inside the receiving compartment 3, and a baking tray 5 configured to be supported by the cooking recipient 4 and intended to support the foodstuffs to be cooked.

As shown in the figures, the cooking recipient 4 includes a recipient bottom 6 and peripheral walls 7 which extend from the recipient bottom 6 and which delimit, together with the recipient bottom 6, a cooking volume 8. The recipient bottom 6 extends substantially horizontally when the cooking recipient 4 is housed in the receiving compartment 3 and the casing 2 rests on a horizontal surface. More particularly, the baking tray 5 includes a lower face configured to be oriented towards the recipient bottom 6, and an upper face over which foodstuffs to be cooked are intended to be disposed.

The cooking recipient 4 further includes a lower support surface 9 which extends over the inner contour of the cooking recipient 4 and over each of the peripheral walls 7, such that the lower support surface 9 defines an inner peripheral boundary in the cooking volume 8. Advantageously, the recipient bottom 6 and the lower support surface 9 define a lower portion 10 of the cooking recipient 4 whose function will be detailed hereinafter.

According to the embodiment shown in FIGS. 1 to 7, the cooking recipient 4 has a cross-section with a substantially rectangular shape, and is configured to cooperate by form-fitting with the baking tray 5.

In order to facilitate handling and cleaning of the cooking recipient 4, the latter is advantageously removable with respect to the casing 2.

According to the embodiment shown in FIGS. 1 to 7, the baking tray 5 is apertured and could be assimilated to a cooking grid. Advantageously, such a configuration of the baking tray 5 enables the cooking juices produced by the foodstuffs during cooking to flow by gravity into the lower portion 10 of the cooking recipient 4.

The electric cooking appliance 1 further comprises a hot-air heating system 11 configured to heat and cook the foodstuffs present inside the receiving compartment 3 according to at least one hot-air cooking mode. Advantageously, the hot-air heating system 11 is provided in an upper portion of the casing 2, and includes a fan 11.1 configured to generate an airflow in the cooking volume 8. The hot-air heating system 11 further includes a drive unit 11.2 configured to drive the fan 11.1 in rotation during use of the electric cooking appliance 1 in the hot-air cooking mode. The hot-air heating system 11 further includes a heating member 11.3, such as a heating electric resistance, configured to heat the airflow generated by the fan 11.1. Advantageously, and in order to obtain an effective hot-air cooking, the fan 11.1 and the heating member 11.3 are configured to extend substantially opposite the baking tray 5, and consequently opposite the foodstuffs present on the baking tray 5.

The electric cooking appliance 1 further includes a positioning system 12 configured to position the baking tray 5 according to a first cooking position in which the baking tray 5 extends in a first cooking plane P1 and is located at a first distance from the recipient bottom 6, and according to a second cooking position in which the baking tray 5 extends in a second cooking plane P2 and is located at a second distance from the recipient bottom 6 which is smaller than the first distance. Such a configuration of the invention allows modifying the distance between the foodstuffs positioned on the baking tray 5 and the hot-air heating system 11 when the baking tray 5 rests on the cooking recipient 4. This advantageously allows influencing the result expected upon cooking, namely more or less grilled or browned foodstuffs for example. More specifically, cooking foodstuffs disposed on the baking tray 5 occupying the first cooking position allows achieving a first grilled or browned effect, whereas cooking foodstuffs on the baking tray 5 occupying the second cooking position allows obtaining a second grilled or browned effect which is lesser than the first grilled or browned effect.

More particularly, the first cooking plane P1 and the second cooking plane P2 are substantially parallel and are configured to extend substantially horizontally when the casing 2 rests on a horizontal surface. Advantageously, such a configuration of the invention enables a good distribution of the foodstuffs over the baking tray 5 when the baking tray 5 occupies either one of the first and second cooking positions and when the lower casing 2 rests on a horizontal surface.

For obvious reasons related to the use of the electric cooking appliance 1, the cooking recipient 4 includes an access opening delimited by an upper peripheral edge 13 of the cooking recipient 4. The access opening is configured to enable placement of the baking tray 5 in the first cooking position and removal thereof through at least one ascending vertical translational movement, that is to say a movement that is substantially perpendicular to the recipient bottom 6. Such a configuration of the invention and of the access opening enables simplified placement and removal of the foodstuffs on the baking tray 5.

In particular, the positioning system 12 includes a support portion 12.1 disposed in the cooking recipient 4, and a bearing portion disposed on the baking tray 5 and configured to be supported by the support portion 12.1 when the baking tray 5 occupies the first cooking position.

According to the first embodiment of the invention shown in FIGS. 1 to 7, the support portion 12.1 includes support members 14 provided on the cooking recipient 4 and located in the same plane of extension which is parallel to the recipient bottom 6. The support members 14 are configured to project inside the cooking volume 8 and could be assimilated to positioning studs.

The support members 14 are configured to cooperate with and support a peripheral portion 15 of the lower face of the baking tray 5 when the baking tray 5 occupies the first cooking position. Thus, according to the first embodiment of the invention shown in FIGS. 1 to 7, the peripheral portion 15 forms the aforementioned bearing portion, and the baking tray 5 and the bearing portion are made in one-piece.

Advantageously, the cooking recipient 4 includes four support members 14 distributed over two opposite peripheral walls 7 of the cooking recipient 4 such that two of the support members 14 are provided on a first peripheral wall 7 and that the other two support members 14 are provided on a peripheral wall 7 opposite the first peripheral wall 7. Each support member 14 includes an upper support face 16 configured to support a respective portion of a lower face of the peripheral portion 15 when the baking tray 5 occupies the first cooking position.

According to the first embodiment of the invention, the support members 14 are configured to enable passage of the baking tray 5 from the first cooking position into the second cooking position by inclination of the baking tray 5 about an axis of inclination which is substantially horizontal and passing through two opposite peripheral walls 7 of the cooking recipient 4 which do not include the support member 14. Such a configuration of the invention allows easily displacing the baking tray 5 from the first cooking position towards the second cooking position, and that being so without any mechanical modification of the baking tray 5.

According to the first embodiment of the invention, the lower support surface 9 partially forms the positioning system 12, and is configured to support the baking tray 5 horizontally and in the second cooking position.

A method for using the electric cooking appliance 1 according to the first embodiment of the invention is described hereinafter.

When a user wishes to carry out cooking of a foodstuff on the baking tray 5 occupying the second cooking position, and more particularly displace the baking tray 5 from the first cooking position to the second cooking position, the use method comprises the following steps:
lifting the baking tray 5 from the first cooking position and at a distance from the support members 14, for example according to a first ascending translational movement substantially perpendicular to the first cooking plane P1,
pivoting the baking tray 5 about a first pivot axis substantially parallel to the first cooking plane P1 (and therefore substantially horizontal) in a first pivot direction and according to a first pivot angle comprised between 10 degrees and 70 degrees, advantageously between 20 degrees and 60 degrees, and like for example 40 degrees,
displacing the baking tray 5 between the support members 14 and in the direction of the recipient bottom 6 until the baking tray 5 is located below the support members 14, for example according to a second descending translational movement substantially perpendicular to the first cooking plane P1,
pivoting the baking tray 5 about a second pivot axis substantially parallel to the first cooking plane P1, in a second pivot direction opposite to the first pivot direction and according to a second pivot angle substantially identical to the first pivot angle, such that the baking tray 5 extends substantially parallel to the second cooking plane P2,
displacing the baking tray 5 in the direction of the recipient bottom 6 until reaching the second cooking position, for example according to a third descending translational movement substantially perpendicular to the second cooking plane P2.

A user wishing to displace the baking tray 5 from the second cooking position to the first cooking position can easily perform the above-described manipulations according to a reversed sequence.

A second embodiment of the invention is shown in FIGS. 8 to 10. The second embodiment of the invention differs from the first embodiment essentially by the positioning and the configuration of the support members 14.

According to the second embodiment of the invention, the cooking recipient 4 includes three support members 14, two of the support members 14 being provided on a first peripheral wall 7 whereas the third support member 14 is provided on a peripheral wall 7 opposite to the first peripheral wall 7.

The configuration of the support members 14 is also different between the first and second embodiments of the invention in that each of the support members 14 includes two lateral guide portions 17 substantially parallel to one another and configured to enable indexing and guidance of the baking tray 5 during displacement thereof towards the second cooking position. Each lateral guide portion 17 is configured to extend substantially vertically when the casing 2 rests on a horizontal surface.

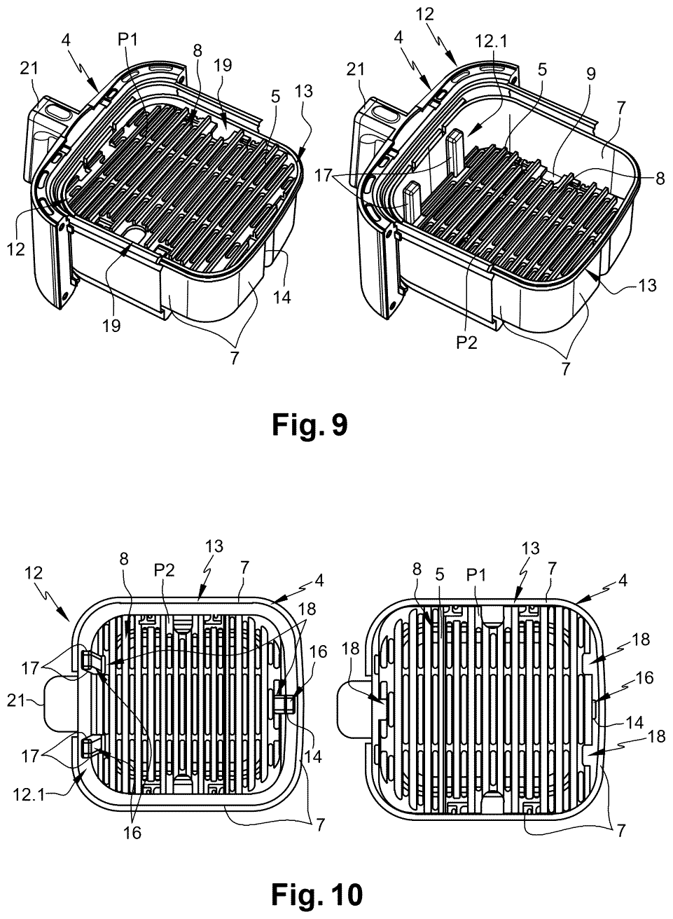

Each of FIGS. 9 and 10 shows the baking tray 5 respectively in the first cooking position and in the second cooking position.

Moreover, the second embodiment of the invention differs from the first embodiment of the invention in that the baking tray 5 further includes positioning recesses 18, such as positioning grooves for example, provided on the baking tray 5. Thus, the positioning system 12 is configured so as to enable a displacement of the baking tray 5 in the second cooking position through a substantially vertical translational movement when each support member 14 is located opposite a respective positioning recess.

The positioning recesses 18 of the baking tray 5 are asymmetrical with respect to a midplane of the baking tray 5 which is perpendicular to a plane of extension of the baking tray 5. The midplane allows defining a symmetry of the contour of the baking tray 5 (positioning recesses 18 excluded). Such a configuration of the invention enables a cooperation between the baking tray 5 and an upper portion of the cooking recipient 4 according to at least two different orientations of the baking tray 5, and for example according to a first orientation, with respect to the cooking recipient 4, when the baking tray 5 occupies the first cooking position, and according to a second orientation, with respect to the cooking recipient 4, when the baking tray 5 occupies the second cooking position, the first orientation and the second orientation being angularly shifted, for example by a 90° or 180° angle, around an axis of rotation which is transverse to the first cooking plane P1.

According to the second embodiment shown in FIGS. 8 to 10, the baking tray 5 advantageously includes gripping means 19, such as gripping openings for example, configured to enable gripping of the baking tray 5 by insertion of the fingers of the user. Advantageously, the gripping means 19 enable gripping of the baking tray 5 by the user in the first cooking position and in the second cooking position.

According to the second embodiment of the invention, the cooking recipient 4 further includes a gripping handle 21 configured to enable placement and removal of the cooking recipient 4 into and out of the receiving compartment 3, for example through a translational movement. The gripping handle 21 is provided on an external face of one of the peripheral walls 7 and extends substantially vertically. Advantageously, the electric cooking appliance 1 is configured such that the translational movement is substantially horizontal when the casing 2 rests on a horizontal surface.

A method for using the electric cooking appliance 1 according to the second embodiment of the invention is described hereinafter.

When a user wishes to carry out cooking of a foodstuff on the baking tray 5 occupying the second cooking position, and more particularly displace the baking tray 5 form the first cooking position to the second cooking position, the use method comprises the following steps:
lifting the baking tray 5 from the first cooking position and at a distance from the support members 14, for example according to a first ascending translational movement substantially perpendicular to the first cooking plane P1,
pivoting the baking tray 5 about a pivot axis which is substantially perpendicular to the first cooking plane P1, so as to position the positioning recesses 18 opposite the support members 14, the pivoting of the baking tray 5 being advantageously carried out through a rotation of the baking tray 5 by 180° about the pivot axis,
displacing the baking tray 5 in the direction of the recipient bottom 6 until reaching the second cooking position, for example according to a second descending translational movement substantially perpendicular to the first cooking plane P1.

A user wishing to switch from the second cooking position into the first cooking position can easily perform the above-described manipulations according to a reversed sequence.

Independently of the above-described two embodiments of the invention, the electric cooking appliance 1 may have variants detailed hereinafter. The casing 2 could include a cap configured to alternately occupies a closure position in which the cap prevents access to the receiving compartment 3, and an opening position in which the cap enables access to the receiving compartment 3. In this variant, the cap is pivotably mounted about a pivot axis which is substantially horizontal when the casing 2 rests on a horizontal surface.

Of course, the present invention is in no way limited to the described and illustrated embodiments which have been given merely as examples. Modifications are still possible, in particular with regards to the construction of the various elements or by substitution with technical equivalents, yet without departing from the scope of the invention.

1. An electric cooking appliance configured to carry out foodstuff cooking, comprising:
a casing comprising a receiving compartment;
a cooking recipient configured to be housed at least partially inside the receiving compartment, the cooking recipient comprising a recipient bottom and peripheral walls extending from the recipient bottom, wherein the peripheral walls and the recipient bottom define a cooking volume;
a baking tray configured to be supported by the cooking recipient and to support foodstuffs to be cooked;
a hot-air heating system configured to heat and cook foodstuffs present inside the receiving compartment according to at least one hot-air cooking mode;
wherein the electric cooking appliance comprises a positioning system configured to position the baking tray in at least a first cooking position in which the baking tray extends in a first cooking plane and is located a first distance from the recipient bottom, and in a second cooking position in which the baking tray extends in a second cooking plane and is located a second distance from the recipient bottom which is smaller than the first distance, and wherein the positioning system comprises a support portion disposed in the cooking recipient and a bearing portion disposed on the baking tray, the bearing portion configured to be supported by the support portion when the baking tray is in the first cooking position.

2. The electric cooking appliance according to claim 1, wherein the baking tray is configured to be oriented, with respect to the cooking recipient, in a first relative orientation when the baking tray occupies the first cooking position, and to be oriented, with respect to the cooking recipient, in a second orientation when the baking tray occupies the second cooking position, the first orientation and the second orientation being angularly offset from one another around an axis of rotation that is transverse to the first cooking plane.

3. The electric cooking appliance (according to claim 1, wherein the baking tray and the bearing portion are made in one-piece.

4. The electric cooking appliance according to claim 1, wherein the first cooking plane and the second cooking plane are substantially parallel and are configured to extend substantially horizontally when the casing rests on a horizontal surface.

5. The electric cooking appliance (according to claim 1, wherein the cooking recipient includes an access opening defined by an upper peripheral edge of the cooking recipient, the access opening being configured to enable placement and removal of the baking tray into and out of the cooking volume.

6. The electric cooking appliance according to claim 1, wherein the support portion includes support members provided on the cooking recipient and configured to cooperate with and support the bearing portion disposed on the baking tray when the baking tray is in the first cooking position.

7. The electric cooking appliance according to claim 6, wherein the baking tray includes a lower face configured to be oriented towards the recipient bottom and an upper face on which foodstuffs are intended to be disposed, the support members being configured to cooperate with a peripheral portion of the lower face of the baking tray when the baking tray is in the first cooking position, the peripheral portion defining the bearing portion.

8. The electric cooking appliance according to claim 6, wherein each support member is configured to project inside the cooking volume.

9. The electric cooking appliance according to claim 6, wherein the bearing portion, disposed on the baking tray, is configured to rest on a lower support surface provided on the cooking recipient when the baking tray is in the second cooking position, said lower support surface partially defining the positioning system.

10. The electric cooking appliance according to claim 6, wherein the support members are provided on at least two peripheral walls of the cooking recipient.

11. The electric cooking appliance according to claim 6, wherein the positioning system includes positioning recesses provided on the baking tray, the positioning system being configured to enable a displacement of the baking tray in the second cooking position, when each support member is located opposite a respective positioning recess.

12. The electric cooking appliance according to claim 11, wherein the positioning recesses are asymmetrical with respect to a midplane of the baking tray which is perpendicular to a plane of extension of the baking tray.

13. The electric cooking appliance according to claim 6, wherein at least one of the support members includes two lateral guide portions substantially parallel to one another and configured to enable indexing and guidance of the baking tray during movement towards the second cooking position.

14. The electric cooking appliance according to claim 1, wherein the baking tray defines at least one aperture, such that cooking juices produced by foodstuffs disposed on the baking tray could flow by gravity in a lower portion of the cooking recipient.

15. A method for using the electric cooking appliance according to claim 1, the method comprising pivoting the baking tray about a pivot axis to reach either one of the first cooking position or the second cooking position.

16. A method for using the electric cooking appliance according to claim 11, the method comprising at least one step of pivoting the baking tray about a pivot axis to reach either one of the first cooking position or the second cooking position; and
displacing the baking tray from the first cooking position to the second cooking position comprising at least the following steps:
lifting the baking tray from the first cooking position and moving the baking tray a distance from the support members,
pivoting the baking tray about a pivot axis which is substantially perpendicular to the first cooking plane, so as to position the positioning recesses opposite the support members, and
displacing the baking tray in the direction of the recipient bottom until reaching the second cooking position.

17. A method for using the electric cooking appliance according to claim 6, the method comprising at least one step of pivoting the baking tray about a pivot axis to reach either one of the first cooking position or the second cooking position; and
displacing the baking tray from the first cooking position to the second cooking position comprising at least the following steps:
lifting the baking tray from the first cooking position and moving the baking tray a distance from the support members,
pivoting the baking tray about a first pivot axis substantially parallel to the first cooking plane in a first pivot direction and according to a first pivot angle ranging between 10 degrees and 70 degrees,
displacing the baking tray between the support members and in the direction of the recipient bottom until the baking tray is located below the support members,
pivoting the baking tray about a second pivot axis substantially parallel to the first cooking plane, in a second pivot direction opposite to the first pivot direction and according to a second pivot angle substantially identical to the first pivot angle, such that the baking tray extends substantially parallel to the second cooking plane, and
placing the baking tray in the second cooking position.

18. A method for using the electric cooking appliance according to claim 12, the method comprising at least one step of pivoting the baking tray about a pivot axis to either one of the first cooking position or the second cooking position; and
displacing the baking tray from the first cooking position to the second cooking position comprising at least the following steps:
lifting the baking tray from the first cooking position and moving the baking tray a distance from the support members,
pivoting the baking tray about a pivot axis which is substantially perpendicular to the first cooking plane, so as to position the positioning recesses opposite the support members, and
displacing the baking tray in the direction of the recipient bottom until reaching the second cooking position.

19. A method for using the electric cooking appliance according to claim 7, the method comprising at least one step of pivoting the baking tray about a pivot axis to either one of the first cooking position or the second cooking position; and
displacing the baking tray from the first cooking position to the second cooking position comprising at least the following steps:
lifting the baking tray from the first cooking position and moving the baking tray a distance from the support members,
pivoting the baking tray about a first pivot axis substantially parallel to the first cooking plane in a first pivot direction and according to a first pivot angle ranging between 10 degrees and 70 degrees,
displacing the baking tray between the support members and in the direction of the recipient bottom until the baking tray is located below the support members,
pivoting the baking tray about a second pivot axis substantially parallel to the first cooking plane, in a second pivot direction opposite to the first pivot direction and according to a second pivot angle substantially identical to the first pivot angle, such that the baking tray extends substantially parallel to the second cooking plane, and
placing the baking tray in the second cooking position.

20. A method for using the electric cooking appliance according to claim 9, the method comprising pivoting the baking tray about a pivot axis to either one of the first cooking position or the second cooking position; and
displacing the baking tray from the first cooking position to the second cooking position comprising at least the following steps:
lifting the baking tray from the first cooking position and moving the baking tray a distance from the support members,
pivoting the baking tray about a first pivot axis substantially parallel to the first cooking plane in a first pivot direction and according to a first pivot angle ranging between 10 degrees and 70 degrees,
displacing the baking tray between the support members and in the direction of the recipient bottom until the baking tray is located below the support members,
pivoting the baking tray about a second pivot axis substantially parallel to the first cooking plane, in a second pivot direction opposite to the first pivot direction and according to a second pivot angle substantially identical to the first pivot angle, such that the baking tray extends substantially parallel to the second cooking plane, and
placing the baking tray in the second cooking position.
